(19) United States
(12) Patent Application Publication
(10) Pub. No.: US 2011/0074775 A1
(43) Pub. Date: Mar. 31, 2011

(54) IMAGE SIGNAL PROCESSING DEVICE AND IMAGE SIGNAL PROCESSING METHOD

(76) Inventors: Ryuichi Shibutani, Osaka (JP); Hideki Morino, Osaka (JP); Haruko Terai, Osaka (JP); Nobutoshi Fujinami, Osaka (JP)

(21) Appl. No.: 12/993,849

(22) PCT Filed: Sep. 18, 2009
(86) PCT No.: PCT/JP2009/004707

§ 371 Date: Nov. 22, 2010

(30) Foreign Application Priority Data
Sep. 26, 2008 (JP) 2008-247871

(51) Int. Cl. G06T 15/00

(52) U.S. Cl. 345/419

(57) ABSTRACT

An image signal processing device is a stereoscopic image display device displaying a stereoscopic image on a screen with right- and left-eye image signals including parallax therebetween, the device including a parallax detecting unit for detecting information about parallax between right- and left-eye image signals; a non-parallax signal generating unit generating a signal produced by eliminating parallax between right- and left-eye image signals according to the parallax information; a right-left level difference detecting unit generating information about a level difference between non-parallax, right- and left-eye image signals free from parallax therebetween; and a level difference correcting unit correcting right- and left-eye image signals for each given level according to the level difference information.

### TECHNICAL FIELD

The present invention relates to an image display device displaying an object three-dimensionally, particularly to an image signal processing device using a left-eye image signal and a right-eye image signal for an object.

### BACKGROUND ART

To display an image three-dimensionally on an image display device, various methods are examined. Among them, the following method is well known. That is, a right-eye image and a left-eye image of an object are prepared; a mechanism is provided that allows a viewer to view these images with the right and left eyes separately to present a stereoscopic image of the object. Viewing something with the human eye produces parallax between images by the right and left eyes for a same object. The parallax allows the human to perceive an object three-dimensionally and to sense the depth of the object. Accordingly, to prepare right- and left-eye image signals including such parallax allows implementing an image display device enabling an object to be viewed three-dimensionally.

Next, a description is made of parallax between right- and left-eye images. For instance, as the object in the right-eye image shifts to the left; and as the object in the left-eye image shifts to the right, the object appears to project forward. Reversely, as the object in the right-eye image shifts to the right; and as the object in the left-eye image shifts to the left, the object appears to be withdrawn backward. Without parallax (the right-eye image is identical to the left-eye image), the object appears to be positioned at the display surface of the image display device.

A stereoscopic image including parallax is easily obtained through shooting an object with two cameras of the same type. Usually, the right-eye camera is positioned on the right; and the left-eye camera, on the left.

Next, each image signal obtained from the right- and left-eye cameras is transmitted to an image display device. Then, the image display device has only to provide a mechanism that allows each image signal from the cameras to be viewed with the right and left eyes. Various methods have been devised according to such a mechanism. To transmit image signals for stereo vision, both right- and left-eye image signals need to be sent. Hence, to transmit these signals directly, the transmission rate increases to twice that of a regular case.

In field sequential method shown in FIG. 6A, for instance, left-eye image L and right-eye image R are arranged in time series by frame for transmission. This method provides images free from deterioration in both vertical and horizontal resolutions as compared to two-dimensional display. The transmission rate, however, increases to twice that of a regular case.

To reduce the transmission rate, several types of methods are disclosed as shown in FIGS. 6B, 6C, and 6D. In side-by-side method shown in FIG. 6B, left-eye image L and right-eye image R, with their horizontal resolutions being ½, are positioned in the left half and the right half of one frame, respectively, for transmission. This method, however, produces deterioration in horizontal resolution. In vertical interleave method shown in FIG. 6C, left-eye image L and right-eye image R are multiplexed for every one line vertically for transmission. This method, however, produces deterioration in vertical resolution. In checker pattern method shown in FIG. 6D, left-eye image R and right-eye image L are arranged in a staggered pattern by pixel for transmission. This method, however, produces deterioration in both horizontal and vertical resolutions.

Meanwhile, an image display device employs various methods. In active shutter method, for instance, right-eye image R and left-eye image L are arranged in time series and displayed sequentially. By using shutter glasses that open and close shutters for the right- and left-eye lenses in accordance with right-eye image R and left-eye image L, respectively, right-eye image R and left-eye image L result in being viewed by the right and left eyes, respectively. This provides a stereoscopic image of an object. (Refer to patent literature 1.)

Thus using right-eye image R and left-eye image R including parallax therebetween provides stereo vision. Right-eye image R and left-eye image L are usually obtained through shooting an object with two cameras positioned separately from each other at a certain distance so as to obtain parallax. This causes unevenness (e.g. contrast, black level, and depth of a color in images) in a signal state of right-eye image R and left-eye image L.

In the conventional technology, displaying right-eye image R and left-eye image R on a display device causes unevenness (e.g. contrast, black level, and depth of a color in images) in an image state due to two cameras being used, thereby sometimes giving unnatural visual feeling.

### PRIOR ART DOCUMENTS

[Patent literature]

[Patent literature 1] Japanese Patent Unexamined Publication No. 2002-262310

### SUMMARY OF THE INVENTION

An image signal processing device of the present invention is a stereoscopic image display device that displays a stereoscopic image by means of right- and left-eye image signals including parallax therebetween. The device includes a parallax detecting unit; a non-parallax signal generating unit; a right-left level difference detecting unit; and a level difference correcting unit. The parallax detecting unit detects parallax information on the basis of parallax from right- and left-eye image signals. The non-parallax signal generating unit generates non-parallax, right- and left-eye image signals free from parallax therebetween. The right-left level difference detecting unit detects a level difference between non-parallax, right- and left-eye image signals to produce level difference information. The level difference correcting unit corrects right- and left-eye image signals according to level difference information for each given level.

With such a configuration, right- and left-eye image signals are corrected for each given level according to level difference information obtained by the right-left level difference detecting unit, thereby reducing unnatural visual feeling produced from different signal levels between right- and left-eye image signals including parallax therebetween.

An image signal processing method of the present invention includes a parallax detecting step; a non-parallax signal generating step; a right-left level difference detecting step; and level difference correcting step, in a stereoscopic image display device that displays a stereoscopic image by means of right- and left-eye image signals including parallax therebetween. The parallax detecting step detects parallax information on the basis of parallax from right- and left-eye image signals, in the parallax detecting unit. The non-parallax signal generating step generates non-parallax, right- and left-eye image signals free from parallax therebetween, in the non-parallax signal generating unit. The right-left level difference detecting step detects a level difference between non-parallax, right- and left-eye image signals to produce level difference information, in the right-left level difference detecting unit. The level difference correcting step corrects right- and left-eye image signals according to level difference information for each given level, in the level difference correcting unit.

### BRIEF DESCRIPTION OF DRAWINGS

FIG. 1 is a block diagram showing the configuration of an image signal processing device according to an embodiment of the present invention.

FIG. 2 shows an example of an image produced by displaying on a screen an image signal input to the image signal processing device according to the embodiment of the present invention.

FIG. 3 is a block diagram showing the configuration of another example of an image signal processing device according to the embodiment of the present invention.

FIG. 4 is a block diagram showing the configuration of yet another example of an image signal processing device according to the embodiment of the present invention.

FIG. 5 is a flowchart of the image signal process in the image signal processing device according to the embodiment of the present invention.

FIG. 6A shows an example of a transmission format in conventional stereo vision.

FIG. 6B shows an example of a transmission format in conventional stereo vision.

FIG. 6C shows an example of a transmission format in conventional stereo vision.

FIG. 6D shows an example of a transmission format in conventional stereo vision.

### DETAILED DESCRIPTION OF PREFERRED EMBODIMENT

Hereinafter, a description is made of an embodiment of the present invention with reference to the related drawings.

### Exemplary Embodiment

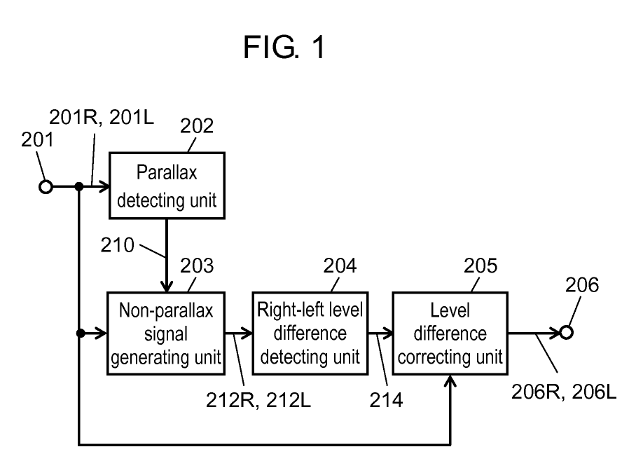

FIG. 1 is a block diagram showing the configuration of an image signal processing device according to an embodiment of the present invention. As shown in FIG. 1, the image signal processing device according to the embodiment is composed of parallax detecting unit 202 including image signal input terminal 201; non-parallax signal generating unit 203; right-left level difference detecting unit 204; and level difference correcting unit 205 including image signal output terminal 206. The image signal processing device receives right-eye image signal 201R and left-eye image signal 201L including parallax therebetween, through image signal input terminal 201; and outputs right-eye image signal 206R and left-eye image signal 206L, both having been corrected, through image signal output terminal 206. Right-eye image signal 206R and left-eye image signal 206L including parallax therebetween and having been corrected, are displayed on the screen of a display device (not shown) as a stereoscopic image.

Parallax detecting unit 202 detects parallax information on the basis of parallax between right-eye image signal 201R and left-eye image signal 201L. Parallax detecting unit 202 outputs parallax information detected as parallax degree signal 210. Non-parallax signal generating unit 203 receives right-eye image signal 201R and left-eye image signal 201L. Then, non-parallax signal generating unit 203 shifts the phase of at least one of right-eye image signal 201R and left-eye image signal 201L, according to parallax information output from parallax detecting unit 202. Next, parallax detecting unit 202 generates non-parallax right- and left-eye image signals 212R and 212L free from parallax therebetween, and then outputs them.

Right-left level difference detecting unit 204 receives non-parallax right- and left-eye image signals 212R and 212L output from non-parallax signal generating unit 203. Then, right-left level difference detecting unit 204 detects a level difference between right-eye image signal 201R and left-eye image signal 201L to produce level difference information. Next, right-left level difference detecting unit 204 outputs the level difference information detected as level difference signal 214.

Level difference correcting unit 205 receives right-eye image signal 201R and left-eye image signal 201L. Then, level difference correcting unit 205 corrects a level difference between right-eye image signal 201R and left-eye image signal 201L according to level difference signal 214 (i.e. level difference information) output from right-left level difference detecting unit 204. As a result, level difference correcting unit 205 sets right-eye image signal 206R and left-eye image signal 206L for each given level. Here, the given level has only to be set to a level such that a user cannot perceive the differences. Further, level difference correcting unit 205 may correct right-eye image signal 206R and left-eye image signal 206L so that they are substantially at the same level. Doing so reduces unnatural visual feeling produced from different signal levels between right-eye image signal 201R and left-eye image signal 201L.

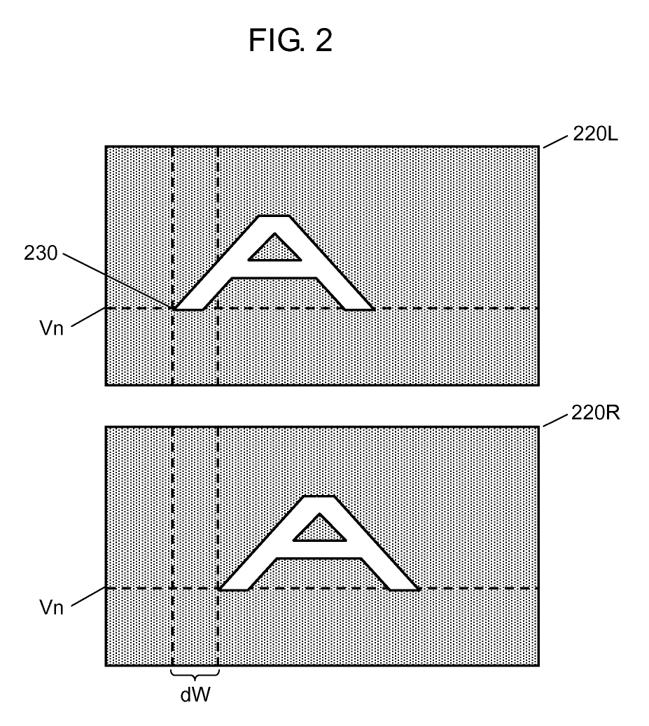

Next, a description is made of operation in each configuration described above, taking concrete examples. As described using FIG. 1, right-eye image signal 201R and left-eye image signal 201L including parallax therebetween are input to image signal input terminal 201 of the image signal processing device. FIG. 2 shows an example of an image produced by displaying on a screen an image signal input to the image signal processing device according to the embodiment of the present invention.

In field sequential method for instance, as shown in FIG. 2, displaying on a screen right-eye image signal 201R and left-eye image signal 201L input to the image signal processing device is assumed to produce right-eye image 220R and left-eye image 220L. Each of right-eye image 220R and left-eye image 220L presents a character “A” as an object including parallax (i.e. phase difference). In other words, right-eye image signal 201R and left-eye image signal 201L, including a phase difference, are produced by shooting an object with different cameras. Hence, as shown in FIG. 2, right-eye image 220R and left-eye image 220L based on the image signals include a common part with a phase difference (a parallax degree of dW).

Parallax detecting unit 202 operates in the following way in order to detect parallax degree dW as parallax information based on the parallax. That is, parallax detecting unit 202 shifts the phase of left-eye image 220L stepwise by pixel sampling unit on a certain image line Vn, for instance. Then, parallax detecting unit 202 detects a difference between left-eye image 220L and right-eye image 220R each time shifting the phase. Next, parallax detecting unit 202 presumes the amount of phase shift at a minimum difference as parallax degree dW.

In this case, image line Vn is desirably set so as to include an object. Attention-focused pixel 230 including a singular part is desirably set to such as the boundary of an object. This is because the brightness and color tone of a pixel are assumed to change largely around the boundary of an object. Image line Vn may be set so as to include attention-focused pixel 230. Image line Vn, however, does not necessarily need to be set so as to include attention-focused pixel 230 if the amount of phase shift is easily detected at a part other than attention-focused pixel 230.

As shown in FIG. 2, parallax detecting unit 202 may detect the amount of phase shift using not only attention-focused pixel 230 including a singular part but plural pixels around attention-focused pixel 230 in order to increase the accuracy of detecting the amount of phase shift. That is, parallax detecting unit 202 judges whether the amount of phase shift does not vary for attention-focused pixel 230 and plural pixels therearound. As the result, parallax detecting unit 202 may determine the result of detecting parallax with a maximum number of pixels having the same result, as that of attention-focused pixel 230. In this way, detection is made using a larger number of pixels, thus reducing influence of such as noise. Hence, parallax detecting unit 202 increases the accuracy of detecting the amount of phase shift. In this example, parallax detecting unit 202 sets attention-focused pixel 230 in left-eye image 220L; however, may set in either right-eye image 220R or left-eye image 220L.

Parallax detecting unit 202 inputs parallax degree dW thus obtained to non-parallax signal generating unit 203 as parallax information. Non-parallax signal generating unit 203 shifts the phase of at least one of right-eye image signal 201R and left-eye image signal 201L according to parallax information for a parallax degree dW of zero. Non-parallax signal generating unit 203 thus obtains non-parallax right- and left-eye image signals 212R and 212L (not including a phase difference in an image signal) and outputs them.

Right-left level difference detecting unit 204 receives non-parallax right- and left-eye image signals 212R and 212L to detect a level difference between them. To correct a brightness difference, for instance, right-left level difference detecting unit 204 detects a difference between the brightness components of non-parallax right- and left-eye image signals 212R and 212L having been input. The detection is made simply by determining the difference between the brightness components of non-parallax right- and left-eye image signals 212R and 212L.

Concretely, the difference between the brightness components can be obtained as follows. That is, a delay circuit is used to superimpose non-parallax left-eye image signal 212L on non-parallax right-eye image signal 212R; and then a difference circuit is used to subtract the level of non-parallax right-eye image signal 212R from that of non-parallax left-eye image signal 212L.

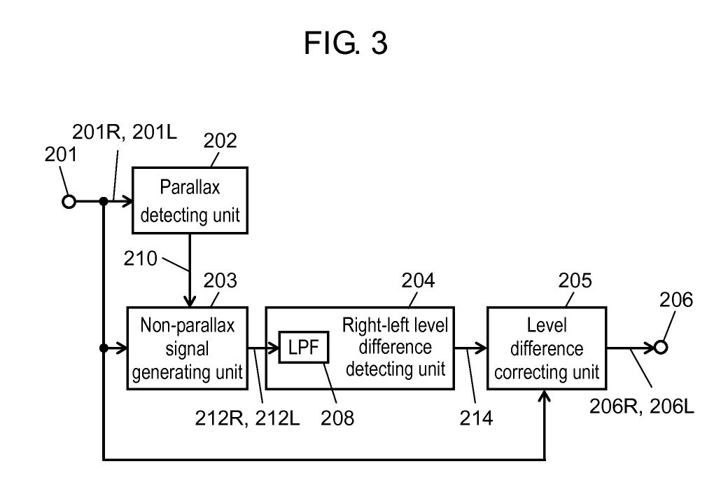

FIG. 3 is a block diagram showing the configuration of another example of an image signal processing device according to the embodiment. The image signal processing device is characterized in that it detects a level difference between low-frequency components of an image signal input to right-left level difference detecting unit 204. As shown in FIG. 3, right-left level difference detecting unit 204 includes in its input unit low-pass filter (hereinafter, abbreviated as LPF) 208 additionally to the configuration of FIG. 1. Here, a component same as that described in FIG. 1 is given the same reference mark to omit its description.

To increase the accuracy of detecting the difference between the brightness components, right-left level difference detecting unit 204 receives non-parallax right- and left-eye image signals 212R and 212L through LPF 208, as shown in FIG. 3. This allows detecting the difference in brightness only with the level difference between low-frequency components of non-parallax right- and left-eye image signals 212R and 212L. Hence, noise (i.e. high-frequency components) can be removed, thereby preventing malfunction caused by noise in detecting the difference between the brightness components. Here, the cutoff frequency of LPF 208 being set to approximately 2 to 3 MHz, for instance, enhances the effect of preventing malfunction caused by noise in detecting the difference between the brightness components.

Next, level difference correcting unit 205 corrects brightness components of right-eye image signal 201R and left-eye image signal 201L according to level difference signal 214 obtained by right-left level difference detecting unit 204. At this moment, determination is needed that either one of right-eye image signal 201R and left-eye image signal 201L is a reference image signal and that the other is an image signal requiring correction. The system needs to uniquely determine which one is to be corrected. The image signal processing device according to the embodiment is assumed to always correct left-eye image signal 201L, for instance, to reduce fluctuation in the signal level. Hence, level difference correcting unit 205 is assumed to subtract brightness components from left-eye image signal 201L to obtain left eye image signal 206L corrected.

Alternatively, not left-eye image signal 201L but right-eye image signal 201R may be always corrected. Instead, to reduce the degree to which the screen darkens, an image signal to be corrected may be selected so as to always keep the higher brightness. Doing so allows reducing the circuit size. Otherwise, right-eye image signal 201R and left-eye image signal 201L may be corrected to the average value of the level of each image signal. Doing so decreases the difference in signal level in between a region corrected and that not corrected, thereby further reducing user's unnatural feeling. In other words, level difference correcting unit 205 may always select one of the following ways. First, correction is made so that one of non-parallax right- and left-eye image signals 212R and 212L becomes substantially same as the other in level. Second, correction is made so as to keep the higher brightness. Third, correction is made to the average value of non-parallax right- and left-eye image signals 212R and 212L.

In this way, level difference correcting unit 205 can obtain right-eye image signal 206R and left-eye image signal 206L with the difference in brightness level corrected.

To correct a color signal level, what is needed is the following. That is, right-left level difference detecting unit 204 detects a difference in color signal level, and level difference correcting unit 205 corrects color signals. Hence, the present invention does not limit a property of a signal to be corrected to the difference in brightness level. In other words, both brightness level and color signal level may be corrected simultaneously, or only one of them may be corrected.

In an image including parallax as shown in FIG. 2, some regions are present in left-eye image 220L, but not in right-eye image 220R. Hence, right-left level difference detecting unit 204 may detect only the difference between non-parallax right- and left-eye image signals 212R and 212L displayed in the center of the screen. Doing so allows right-left level difference detecting unit 204 to reduce the processing time to detect the difference described above.

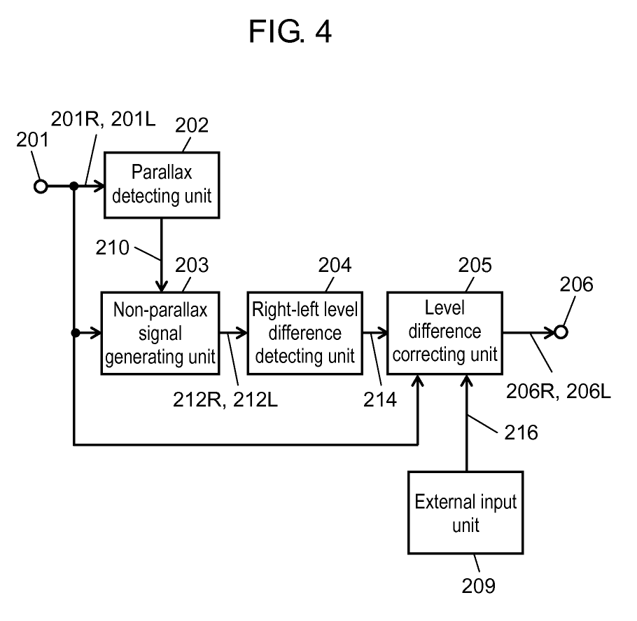

In the image signal processing device according to the embodiment, level difference correcting unit 205 makes setting so that left-eye image signal 201L and right-eye image signal 201R are output at a substantially same level, but not limited to this setting. FIG. 4 is a block diagram showing the configuration of yet another example of an image signal processing device according to the embodiment of the present invention. The image signal processing device is characterized in that correction signal 216 output through external input unit 209 is input to level difference correcting unit 205. The configuration shown in FIG. 4 allows a user to set each signal level of left-eye image signal 201L and right-eye image signal 201R from external input unit 209. For a user having a large difference in eyesight between the right and left eyes (what is called anisometropia), for instance, the image signal processing device may include external input unit 209. Level difference correcting unit 205 may correct at least one of left-eye image signal 201L and right-eye image signal 201R to each given output level according to correction signal 216 output from external input unit 209. Here, the given output level has only to be set to a level such that a user cannot perceive the differences. This allows level difference correcting unit 205 to correct an output level of at least one of left-eye image signal 206L and right-eye image signal 206R according to a user's preferred level. Hence, the image signal processing device can reduce user's unnatural feeling according to a user's preferred level.

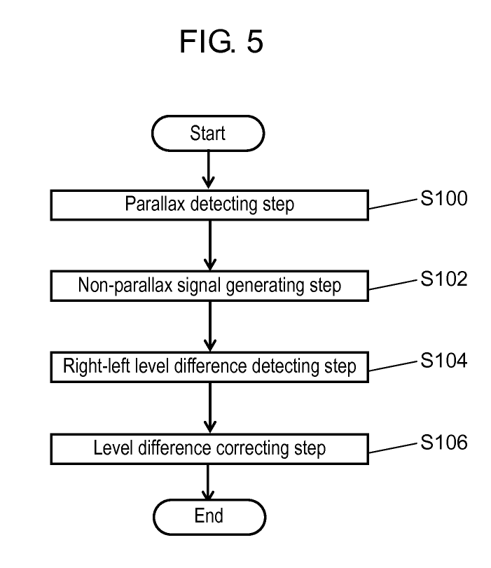

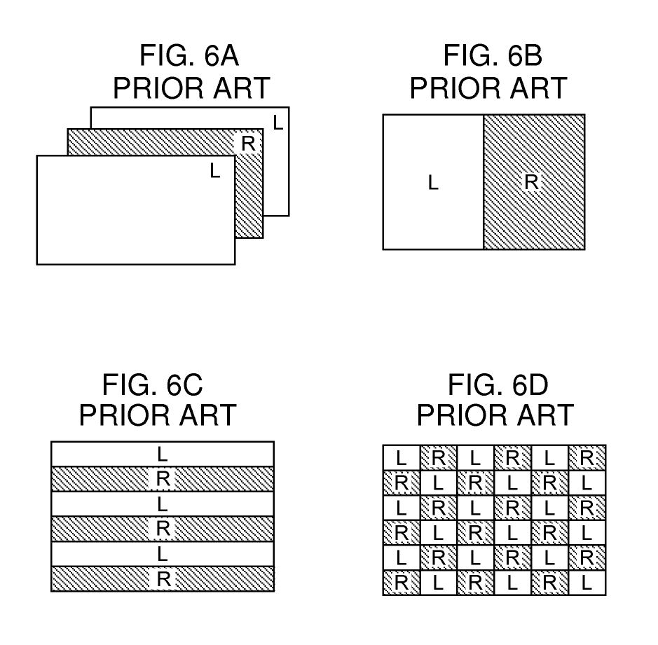

Next, a description is made of a method of processing image signals performed by an image signal processing device according to the embodiment, using the flowchart shown in FIG. 5. FIG. 5 is a flowchart of the image signal process in the image signal processing device according to the embodiment of the present invention. As shown in FIG. 5, the method of processing an image signal in the image signal processing device includes parallax detecting step S100; non-parallax signal generating step S102; right-left level difference detecting step S104; and level difference correcting step S106, in a stereoscopic image display device that displays a stereoscopic image by means of right-eye image signal 201R and left-eye image signal 201L including parallax therebetween.

Parallax detecting step S100 detects parallax information on the basis of parallax from right-eye image signal 201R and left-eye image signal 201L, and then outputs parallax information detected as parallax degree signal 210, in parallax detecting unit 202.

Non-parallax signal generating step S102 shifts the phase of either one of right-eye image signal 201R and left-eye image signal 201L according to parallax information, and then generates non-parallax right- and left-eye image signals 212R and 212L free from parallax therebetween, from right-eye image signal 201R and left-eye image signal 201L according to parallax information, in non-parallax signal generating unit 203. These non-parallax right- and left-eye image signals 212R and 212L are output from non-parallax signal generating unit 203.

Right-left level difference detecting step S104 detects a level difference between non-parallax right- and left-eye image signals 212R and 212L to generate level difference information, in right-left level difference detecting unit 204. Then, level difference signal 214 is output according to the level difference information.

Level difference correcting step S106 corrects right-eye image signal 201R and left-eye image signal 201L for each given level according to level difference information, in level difference correcting unit 205. As the result, right-eye image signal 206R and left-eye image signal 206L are set for each given level, in level difference correcting unit 205. Level difference correcting step S106 may correct right-eye image signal 206R and left-eye image signal 206L for a substantially same level, in level difference correcting unit 205. Doing so reduces unnatural visual feeling produced from different signal levels between right-eye image signal 206R and left-eye image signal 201L including parallax therebetween.

Right-left level difference detecting step S104 may receive non-parallax right- and left-eye image signals 212R and 212L through LPF 208, for instance, in right-left level difference detecting unit 204. By doing so, the step may detect only a level difference between low-frequency components of non-parallax right- and left-eye image signals 212R and 212L, in right-left level difference detecting unit 204. Here, the cutoff frequency of LPF 208 being set to approximately 2 to 3 MHz, for instance, enhances the effect of preventing malfunction caused by noise (high-frequency components) in detecting a level difference.

In an image including parallax as shown in FIG. 2, some regions are present in left-eye image 220L, but not in right-eye image 220R. Hence, level difference correcting step S106 may detect only the difference between non-parallax right- and left-eye image signals 212R and 212L displayed in the center of the screen, for instance, in right-left level difference detecting unit 204. Doing so allows right-left level difference detecting unit 204 to reduce the processing time to detect the difference described above.

Further, as shown in FIG. 4, for a user having a large difference in eyesight between the right and left eyes (what is called anisometropia), for instance, level difference correcting unit 205 may further include an input terminal through which correction signal 216 output from external input unit 209 is input, as in the yet another example of the image signal processing device according to the embodiment. Then, the level difference correcting step may correct at least one of left-eye image signal 201L and right-eye image signal 201R to each given level, according to correction signal 216 input from external input unit 209, if correction signal 216 is input, in level difference correcting unit 205. This allows level difference correcting unit 205 to correct an output level of at least one of left-eye image signal 206L and right-eye image signal 206R according to a user's preferred level. Hence, the image signal processing device can reduce user's unnatural feeling according to a user's preferred level.

Level difference correcting step S106 may always select one of the following ways, in level difference correcting unit 205. First, correction is made so that one of non-parallax right- and left-eye image signals 212R and 212L becomes substantially same as the other in level. Second, correction is made so as to keep the higher brightness. Third, correction is made to the average value of non-parallax right- and left-eye image signals 212R and 212L. In this way, the circuit size can be reduced; the degree to which the screen darkens can be reduced; and user's unnatural feeling can be further reduced because the difference in signal level decreases in between a region corrected and that not corrected.

### INDUSTRIAL APPLICABILITY

The present invention relates to an image signal processing device that adjusts the difference in signal level of between a left-eye image signal and a right-eye image signal in stereo vision to reduce visual uncomfortable feeling.

### REFERENCE MARKS IN THE DRAWINGS

201 Image signal input terminal
201L Left-eye image signal
201R Right-eye image signal
202 Parallax detecting unit
203 Non-parallax signal generating unit
204 Right-left level difference detecting unit
205 Level difference correcting unit
206 Image signal output terminal
206L Left-eye image signal
206R Right-eye image signal
208 Low-pass filter (LPF)
209 External input unit
210 Parallax degree signal
212L Non-parallax left-eye image signal
212R Non-parallax right-eye image signal
214 Level difference signal
216 Correction signal
220L Left-eye image
220R Right-eye image
230 Attention-focused pixel
dW Parallax degree
Vn Image line

1. An image signal processing device that is a stereoscopic display device for displaying a stereoscopic image on a screen with a right-eye image signal and a left-eye image signal including parallax therebetween, comprising:
a parallax detecting unit for detecting parallax information based on the parallax from the right-eye image signal and the left-eye image signal:
a non-parallax signal generating unit for generating a non-parallax right-eye image signal and a non-parallax left-eye image signal free from parallax therebetween, according to the parallax information from the right-eye image signal and the left-eye image signal;
a right-left level difference detecting unit for detecting a level difference between the non-parallax right-eye image signal and the non-parallax left-eye image signal, and for generating level difference information; and
a level difference correcting unit for correcting the right-eye image signal and the left-eye image signal for each given level according to the level difference information.

2. The image signal processing device of claim 1, wherein the level difference correcting unit corrects the right-eye image signal and the left-eye image signal for a substantially same level.

3. The image signal processing device of claim 1, further comprising an external input unit, wherein the image signal processing device corrects at least one of the right-eye image signal and the left-eye image signal for each given output level according to a correction signal input from the external input unit.

4. The image signal processing device of claim 1, wherein the right-left level difference detecting unit further includes a low-pass filter, and wherein the right-left level difference detecting unit receives the non-parallax right-eye image signal and the non-parallax left-eye image signal through the low-pass filter to detect only a level difference between low-frequency components of the non-parallax right-eye image signal and the non-parallax left-eye image signal.

5. The image signal processing device of claim 1, wherein the right-left level difference detecting unit detects only a difference between the non-parallax right-eye image signal and the non-parallax left-eye image signal displayed in a center of the screen.

6. The image signal processing device of claim 1, wherein the level difference correcting unit always selects one of:
correction being made so that one of the non-parallax right-eye image signal and the non-parallax left-eye image signal becomes substantially same as the other in level;
correction being made in accordance with a signal with a higher brightness; and
correction being made to an average value of the non-parallax right-eye image signal and the non-parallax left-eye image signal.

7. An image signal processing method in a stereoscopic image display device for displaying a stereoscopic image on a screen with a right-eye image signal and a left-eye image signal including parallax therebetween, comprising:
a parallax detecting step detecting parallax information based on the parallax from the right-eye image signal and the left-eye image signal, in a parallax detecting unit;
a non-parallax signal generating step generating a non-parallax right-eye image signal and a non-parallax left-eye image signal free from parallax therebetween, according to the parallax information from the right-eye image signal and the left-eye image signal, in a non-parallax signal generating unit ;
a right-left level difference detecting step detecting a level difference between the non-parallax right-eye image signal and the non-parallax left-eye image signal, and generating level difference information, in a right-left level difference detecting unit; and
a level difference correcting step correcting the right-eye image signal and the left-eye image signal for each given level according to the level difference information, in a level difference correcting unit.

8. The image signal processing method of claim 7, wherein the level difference correcting step corrects the right-eye image signal and the left-eye image signal for a substantially same level.

9. The image signal processing method of claim 7, wherein the level difference correcting step corrects at least one of the right-eye image signal and the left-eye image signal to each given output level according to a correction signal input from an external input unit.

10. The image signal processing method of claim 7, wherein the right-left level difference detecting step receives the non-parallax right-eye image signal and the non-parallax left-eye image signal through the low-pass filter to detect only a level difference between low-frequency components of the non-parallax right-eye image signal and the non-parallax left-eye image signal.

11. The image signal processing method claim 7, wherein the right-left level detecting step detects only a difference between the non-parallax right-eye image signal and the non-parallax left-eye image signal displayed in a center of the screen.

12. The image signal processing method of claim 7, wherein the level difference correcting step always selects one of:
correction being made so that one of the non-parallax right-eye image signal and the non-parallax left-eye image signal becomes substantially same as the other in level;
correction being made in accordance with a signal with a higher brightness; and
correction being made to an average value of the non-parallax right-eye image signal and the non-parallax left-eye image signal

13. The image signal processing device of claim 2, wherein the right-left level difference detecting unit detects only a difference between the non-parallax right-eye image signal and the non-parallax left-eye image signal displayed in a center of the screen.

14. The image signal processing method of claim 8, wherein the right-left level detecting step detects only a difference between the non-parallax right-eye image signal and the non-parallax left-eye image signal displayed in a center of the screen.
